(19) United States
(12) Patent Application Publication
(10) Pub. No.: US 2026/0049639 A1
(43) Pub. Date: Feb. 19, 2026

(54) DRIVE ASSEMBLY AND VEHICLE HAVING SUCH A DRIVE ASSEMBLY OF THIS TYPE

(71) Applicant: Robert Bosch GmbH, Stuttgart (DE)

(72) Inventor: Tobias Schlittenbauer, Tamm (DE)

(21) Appl. No.: 19/101,011

(22) PCT Filed: Jul. 3, 2023
(86) PCT No.: PCT/EP2023/068186

§ 371 Date: Feb. 4, 2025

(30) Foreign Application Priority Data
Aug. 4, 2022 (DE) 10 2022 208 109.9

(51) Int. Cl. F16D 1/10; F16H 57/021; F16H 57/04

(52) U.S. Cl. CPC F16D 1/10; F16H 57/021; F16H 57/0421; F16H 57/043; F16H 57/0471; F16D 2001/103; F16D 2300/06

(57) ABSTRACT

The invention relates to a drive assembly (10) comprising: a first shaft (12) with a first toothing (14), a second shaft (16) with a second toothing (18), wherein the first shaft (12) and the second shaft (16) are rotatable about an axis of rotation (20), wherein the second shaft (16) is designed as a hollow shaft, wherein the first toothing (14) of the first shaft (12) and the second toothing (18) of the second shaft (16) form a spline coupling (22) for transmitting a torque, and at least one lubricant channel (24) for conveying lubricant into the second shaft (16). The invention also relates to a vehicle having at least one drive assembly of this type (10).

### BACKGROUND

In drive assemblies with a rotor shaft and a gear shaft that are rotationally coupled to each other by means of spline coupling (or spline toothing), wear and fretting corrosion will occur on the spline coupling over time. To prevent this as far as possible, the spline coupling is lubricated. This can be done by means of grease lubrication, which is sealed by means of O-rings, for example, or by means of a lubricant flow supplied to the spline coupling.

DE 10 2019 219 218 A1 discloses such a drive assembly, wherein the lubrication of the spline coupling can take place by means of a directed flow of lubricant.

The disadvantage of this is that a lubricant pump must often be used to deliver the lubricant for a directed lubricant flow. A directed lubricant flow is often not possible without a lubricant pump.

### SUMMARY

According to the invention, a drive assembly is proposed, in particular for a vehicle, comprising a first shaft with a first toothing. The first shaft can be designed as the rotor shaft of an electric motor.

The drive assembly also comprises a second shaft with a second toothing. The second shaft can be designed as a gearbox input shaft.

The second shaft can be part of a gearbox that is arranged in a gearbox interior.

The first shaft and the second shaft can be rotated about an axis of rotation. The second shaft is designed as a hollow shaft. The first toothing of the first shaft and the second toothing of the second shaft form a spline coupling (or a spline toothing) for transmitting a torque. In other words, the first shaft and the second shaft are rotationally coupled to each other, in particular by means of spline coupling (or spline toothing). The first shaft and second shaft can overlap axially in the area of the spline coupling.

The drive assembly comprises at least one lubricant channel for conveying lubricant into the second shaft. The lubricant channel can be designed as a lubricant fin and/or as a lubricant reservoir. The lubricant may be oil.

The lubricant can thus be conveyed into the second shaft (hollow shaft) via the lubricant channel by means of splash lubrication and transported through the second shaft to the spline coupling. This means that passive forced lubrication of the spline coupling can be implemented without the use of a lubricant pump or oil pump. The drive assembly is therefore in particular an oil pump-free design.

This means that the spline coupling can be supplied with lubricant in a directed manner by means of splash lubrication and lubricated in this way. The particles that may arise within the spline coupling due to wear (or abrasion) can thus be removed with the lubricant. This provides a cost-effective, robust and mechanically simple solution for lubricating the spline coupling. In particular, no seals or other wear-prone elements are required to lubricate the spline coupling.

In the present case, “axial” or “axial direction” refers to a direction aligned along the axis of rotation or parallel to the axis of rotation. In other words, the axis of rotation is oriented in the axial direction. Accordingly, “radial” or “radial direction” refers to a direction perpendicular to the axis of rotation and emanating from the axis of rotation.

According to a further development, the lubricant channel can be arranged in the area of an end of the second shaft facing away from the first shaft. The lubricant channel can open into or protrude into the end facing away from the first shaft. The lubricant can be easily conveyed into the second shaft via the lubricant channel.

According to a further development, the second shaft can have a plug element to prevent lubricant from escaping. The stopper element can be conical in shape. The plug element can be arranged at the end of the second shaft facing away from the first shaft. The plug element can prevent lubricant from escaping from the end of the second shaft facing away from the first shaft. The plug element can be used to prevent unintentional backflow of lubricant from the second shaft, for example back into the gearbox interior. This means that all of the lubricant conveyed into the second shaft is available for lubricating the spline coupling.

According to a further development, the first shaft can have at least one lubricant groove on its outer side for the direct conveyance of lubricant, in particular oil, on the outer side of the first shaft. The lubricant groove can have an axial (axially aligned) section and a radial (radially aligned) section. The shape of the lubricant groove can depend on the contour of the outside of the first shaft. A plurality of lubricant grooves can be provided on the outside of the first shaft, which are distributed at equal angles (equidistant) around the circumference of the first shaft. This allows the lubricant to be conveyed via the outside of the first shaft.

Alternatively or additionally, according to a further development, the first shaft and the second shaft can be supported by means of a (common) bearing. The first shaft and the second shaft can be supported in the area of the spline coupling by means of the (common) bearing. The (common) bearing can comprise a bearing inner ring (and a bearing outer ring). The bearing inner ring can contact the first shaft and the second shaft. For this purpose, the bearing inner ring can optionally have a greater axial length than the bearing outer ring. The bearing inner ring can have at least one lubricant opening for the direct conveyance of lubricant, in particular oil, through the bearing inner ring. The lubricant opening can be designed as a through hole (or oil hole). The lubricant opening can be radially oriented. Several lubricant openings can be provided on the bearing inner ring, which are distributed at equal angles (equidistant) around the circumference of the bearing inner ring. This allows the lubricant to be conveyed specifically through the bearing inner ring.

According to a further development, a radial shaft seal can be arranged on the first shaft. The radial shaft sealing ring can be arranged at an axial distance from the (common) bearing. By means of the radial shaft sealing ring, for example, the electric motor (which can in particular drive the first shaft or rotor shaft) can be sealed from the gearbox interior (or from the lubricant arranged therein).

According to a further development, the drive assembly can have a lubricant guide ring for the direct conveyance of lubricant, in particular oil, to the (common) bearing and/or to the radial shaft sealing ring. The lubricant guide ring can be arranged between the (common) bearing and the radial shaft sealing ring. The lubricant guide ring surrounds the first shaft, in particular radially outwards. The lubricant guide ring is preferably stationary relative to the first shaft (lubricant guide ring does not rotate with the rotating shaft). The lubricant guide ring can be inserted into the housing of the drive assembly to prevent it from rotating.

The lubricant ring can have a first section aligned radially to the first shaft (or to the axis of rotation), in particular adjacent to the first shaft. The lubricant ring can have a second section aligned axially to the first shaft (or to the axis of rotation), in particular at a distance from the first shaft. The first section can be arranged between the second section and the first shaft.

The first section can be adjacent to the second section. By means of the lubricant guide ring (e.g. by selecting the shape and/or dimensions of the lubricant guide ring), the quantity of lubricant that is directed to the (common) bearing and/or the rotary shaft sealing ring can be adjusted as required.

According to a further development, the first toothing of the first shaft can be designed as external toothing and the second toothing of the second shaft as internal toothing.

This means that the first shaft protrudes into the second shaft (hollow shaft), particularly with its first toothing. In other words, the second toothing of the second shaft can be fitted onto the first toothing of the first shaft.

According to a further development, the first shaft can be designed as a hollow shaft, the first toothing of the first shaft as internal toothing and the second toothing of the second shaft as external toothing. This means that the second shaft protrudes into the first shaft (hollow shaft), particularly with its second toothing. In other words, the first toothing of the first shaft can be fitted onto the second toothing of the second shaft.

The drive assembly can, for example, be designed as an E-axis or form part of an E-axis.

According to the invention, a vehicle, in particular a motor vehicle, with at least one drive assembly as described above is proposed. With respect to the advantages that can be achieved in this way, reference is made to the explanations regarding the drive assembly. The measures described and/or discussed below in connection with the drive assembly can serve the further design of the vehicle.

### BRIEF DESCRIPTION OF THE DRAWINGS

Embodiments of the invention are explained below with reference to the accompanying drawings. Shown are:

FIG. 1 a sectional view of a drive assembly according to a first exemplary embodiment;

FIG. 2 a section of a perspective view of a first shaft of the drive assembly according to FIG. 1; and

FIG. 3 a sectional view of the drive assembly according to a second exemplary embodiment.

### DETAILED DESCRIPTION

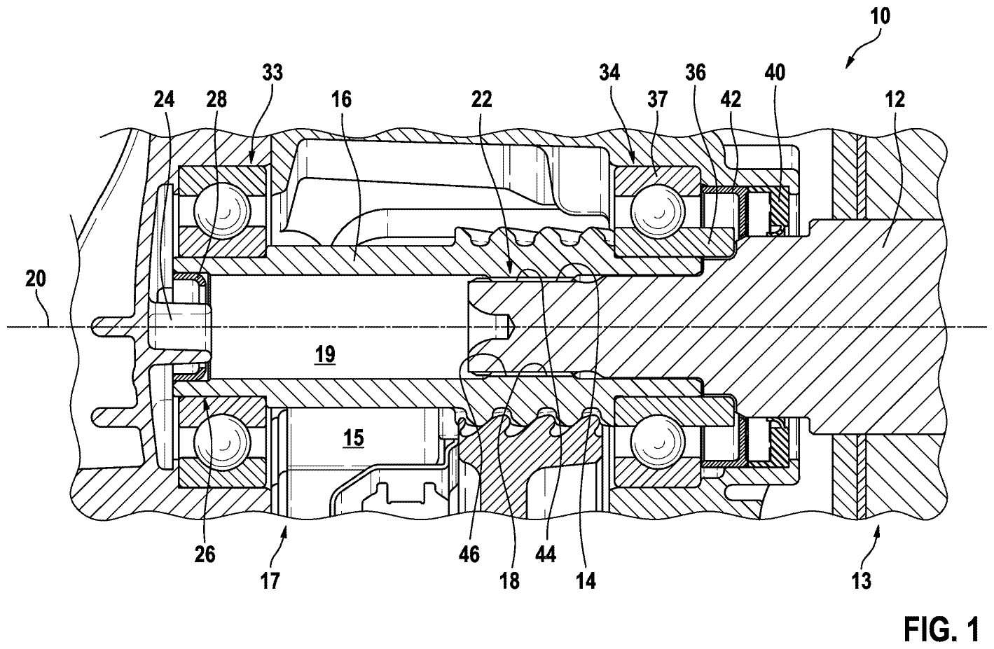

In FIG. 1, the drive assembly as a whole bears the reference number 10. The drive assembly 10 comprises a first shaft 12 with a first toothing 14. In the present case, the first toothing 14 is designed as an external toothing 44. The first shaft 12 is designed as the rotor shaft of an electric motor 13.

The drive assembly 10 has a second shaft 16 with a second toothing 18. The second toothing 18 is designed as internal toothing 46. The second shaft 16 is designed as a gearbox input shaft of a gearbox 17 arranged in a gearbox interior 15.

The first shaft 12 and the second shaft 16 are designed to rotate about an axis of rotation 20. The first shaft 12 protrudes into the second shaft 16, which is designed as a hollow shaft. The toothings 14, 18 of the two shafts 12, 16 form a spline coupling 22. The first shaft 12 and the second shaft 16 are non-rotatably coupled or connected to each other via the spline coupling 22, which is formed by the first toothing 14 and the second toothing 18.

The drive assembly 10 comprises a lubricant channel 24. The lubricant channel 24 is arranged in the area of an end 26 of the second shaft 16 facing away from the first shaft 12 and projects partially into the second shaft 16. The lubricant can thus be conveyed or propelled upwards from a lubricant sump (splash lubrication) in the gearbox interior 15 due to the rotation of the individual elements of the gearbox 17 in FIG. 1. The lubricant thus enters the lubricant channel 24 and is conveyed from there into the second shaft 16.

The drive assembly comprises a plug element 28. The plug element 28 is arranged at the end 26 of the second shaft 16 facing away from the first shaft 12. The plug element 28 is conical and prevents lubricant from leaking out of the second shaft 16.

The second shaft 16 is supported at the end 26 facing away from the first shaft 12 by means of a (further) bearing 33.

The first shaft 12 and the second shaft 16 are supported in the area of the spline coupling 22 by means of a (common) bearing 34. The (common) bearing 34 has an bearing outer ring 36 and an outer bearing ring 37. The bearing outer ring 36 makes contact with the first shaft 12 and the second shaft 16. In the example, the bearing outer ring 36 has a greater axial length than the bearing outer ring 37.

A radial shaft sealing ring 40 is arranged on the first shaft 12. The radial shaft sealing ring 40 seals the electric motor 13 from the gearbox 17 or from the gearbox interior 15. A lubricant guide ring 42 is arranged between the radial shaft sealing ring 40 and the (common) bearing 34. By means of the lubricant guide ring 42, the quantity of lubricant that is directed to the (common) bearing 34 and/or to the radial shaft sealing ring 40 can be adjusted as required.

The lubricant is conveyed into the second shaft 16 via the lubricant channel 24. Due to the rotation of the first shaft 12 and the constant introduction (flow) of lubricant by means of the lubricant channel 24, the lubricant is conveyed to the right, in particular on the inner wall 19 of the second shaft 16 in FIG. 1, in the direction of the spline coupling 22. The lubricant flows through the spline coupling 22, lubricating it.

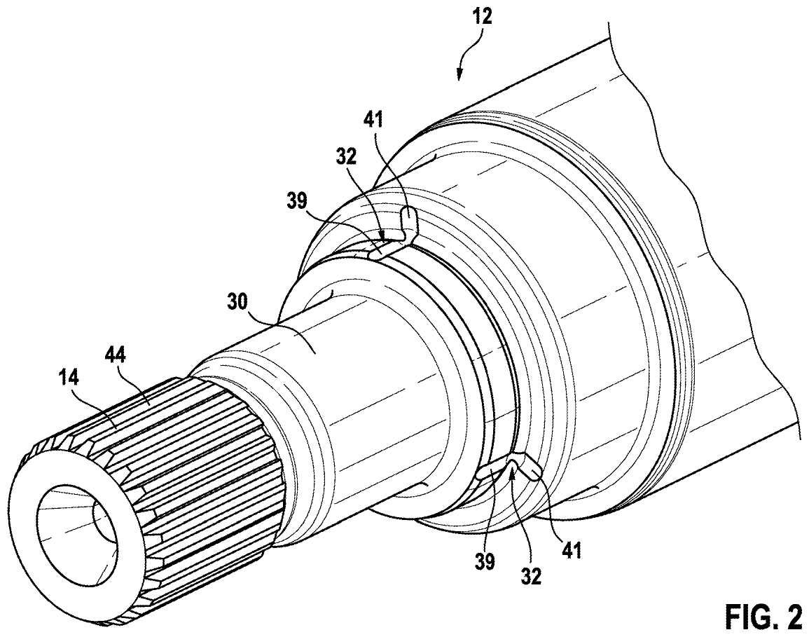

The lubricant continues to flow along the outside 30 (see FIG. 2) of the first shaft 12 until it exits between the bearing inner ring 36 and the lubricant guide ring 42. Here, the lubricant is distributed to the (common) bearing 34 and/or to the rotary shaft sealing ring 40 by means of the lubricant guide ring 42. The lubricant then enters the gearbox interior 15 through the (common) bearing 34 and flows back into the lubricant sump (not shown), in particular due to gravity. From there, it can be redistributed in the gearbox interior 15 and reaches the lubricant channel 28. This closes the lubricant circuit.

FIG. 2 shows a section of a perspective view of the first shaft 12 of the drive assembly 10 as shown in FIG. 1. The first shaft 12 has three lubricant grooves 32 on its outer side 30 (only two of the three lubricant grooves 32 are shown). These are arranged equidistantly along the circumference of the first shaft 12. In other words, the lubricant grooves 32 are equidistant from each other along the circumference of the first shaft 12.

The lubricant grooves 32 each have an axial section 39 and a radial section 41. The course of the lubricant grooves 32 corresponds to the respective contour of the outer side 30 of the first shaft 12. By means of the lubricant grooves 32, the lubricant can be directed along the outer side 30 of the first shaft 12. The lubricant grooves 32 cannot be seen in FIG. 1, as the section shown in FIG. 1 does not run through the lubricant grooves 32.

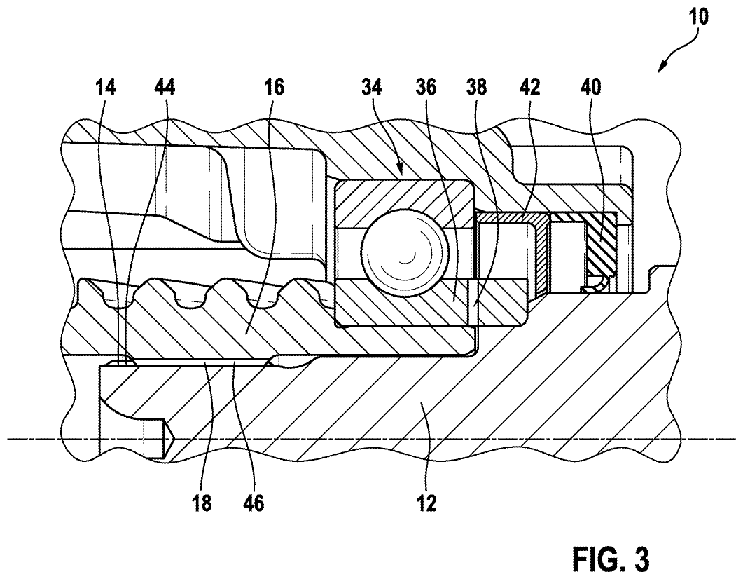

FIG. 3 shows a sectional view of the drive assembly 10 according to a second exemplary embodiment. The second exemplary embodiment differs from the first exemplary embodiment shown in FIGS. 1 and 2 in that the first shaft 12 has no lubricant grooves 32 (lubricant groove-free design).

Instead, the bearing inner ring 36 has several lubricant openings 38. In the present case, these are formed as radially extending holes in the bearing inner ring 36. The lubricant openings open on the radial inside of the bearing inner ring 36 between the first shaft 12 and the second shaft 16. This means that the lubricant escaping between the first shaft 12 and the second shaft 16 can be drained directly to the radial outside by means of the lubricant openings. The lubricant thus reaches the (common) bearing 34 and the lubricant guide ring 42. The lubricant guide ring 42 distributes the lubricant between the (common) bearing 34 and the radial shaft sealing ring 40. The lubricant then passes through the (common) bearing 34 into the gearbox interior 15 (see FIG. 1) and flows back into the lubricant sump, in particular due to gravity. This closes the lubricant circuit.

It is also conceivable that the first exemplary embodiment and the second exemplary embodiment of the drive assembly 10 can be combined with one another, i.e. the drive assembly 10 has the lubricant grooves 32 and the lubricant openings 38.

1. A drive assembly (10), comprising:
a first shaft (12) with a first toothing (14),
a second shaft (16) with a second toothing (18), wherein the first shaft (12) and the second shaft (16) can be rotated about an axis of rotation (20), wherein the second shaft (16) is configured as a hollow shaft,
wherein the first toothing (14) of the first shaft (12) and the second toothing (18) of the second shaft (16) form a spline coupling (22) for transmitting a torque, and
at least one lubricant channel (24) for conveying lubricant, into the second shaft (16).

2. The drive assembly (10) according to claim 1, wherein the lubricant channel (24) is arranged in an area of an end (26) of the second shaft (16) facing away from the first shaft (12).

3. The drive assembly (10) according to claim 1, wherein the second shaft (16), at its end (26) facing away from the first shaft (12), has a conically shaped plug element (28) in order to prevent lubricant from escaping, from the end (26) of the second shaft (16) facing away from the first shaft (12).

4. The drive assembly (10) according to claim 1, wherein the first shaft (12) has at least one lubricant groove (32) on its outer side (30) for direct conveyance of lubricant, on the outer side (30) of the first shaft (12).

5. The drive assembly (10) according to claim 1, where the first shaft (12) and the second shaft (16) are supported, (22), by a bearing (34), wherein the bearing (34) comprises a bearing inner ring (36), wherein the bearing inner ring (36) makes contact with the first shaft (12) and the second shaft (16), wherein the bearing inner ring (36) has at least one lubricant opening (38) for direct conveyance of lubricant, through the bearing inner ring (36).

6. The drive assembly (10) according to claim 1, wherein a radial shaft sealing ring (40) is arranged on the first shaft (12).

7. The drive assembly (10) according to claim 5, wherein the drive assembly (10) has a lubricant guide ring (42) for the direct conveyance of lubricant, to the bearing (34).

8. The drive assembly (10) according to claim 1, wherein the first toothing (14) of the first shaft (12) is configured as external toothing and the second toothing (18) of the second shaft (16) is configured as internal toothing (46).

9. The drive assembly (10) according to claim 1, wherein the first shaft (12) is configured as a hollow shaft, the first toothing (14) of the first shaft (12) is configured as internal toothing and the second toothing (18) of the second shaft (16) is configured as external toothing.

10. A vehicle, having at least one drive assembly (10) according to claim 1.

11. The drive assembly (10) according to claim 1, wherein the drive assembly is for a vehicle.

12. The drive assembly (10) according to claim 1, wherein the lubricant is oil.

13. The drive assembly (10) according to claim 2, wherein the lubricant channel (24) opens into or projects into the end (26) of the second shaft (16) facing away from the first shaft (12).

14. The drive assembly (10) according to claim 5, wherein the first shaft (12) and the second shaft (16) are supported by the bearing (34) in an area of the spline coupling (22).

15. The drive assembly (10) according to claim 6, wherein the drive assembly (10) has a lubricant guide ring (42) for the direct conveyance of lubricant to the bearing (34) and/or to the radial shaft sealing ring (40).

16. The vehicle according to claim 10, wherein the vehicle is a motor vehicle.
